(19) United States
(12) Patent Application Publication
(10) Pub. No.: US 2005/0249389 A1
(43) Pub. Date: Nov. 10, 2005

(54) Rjen fingerprint decoder

(76) Inventor: Joyce Etta Knowles, San Antonio, TX (US)

Correspondence Address: Joyce Etta Knowles, 9507 Shertland Court, San Antonio, TX, 78254, US

(21) Appl. No.: 10/973,484

(22) Filed: Oct. 26, 2004

Related U.S. Application Data
(60) Provisional application No. 60/567,758, filed on May 4, 2004.

(51) Int. Cl. G06K 9/00

(52) U.S. Cl. 382/124

(57) ABSTRACT

The subject Invention, The Rjen Fingerprint Decoder, is designed to analyze an image of a scanned fingerprint and convert the image into a twelve digit numerical code. A numerical value is assigned to various parts of the image based on their relative locations and proximity to lines on a grid formed by vertical and horizontal lines with fixed numerical values. The calculation for each cell of the grid will produce a one digit number value for each cell resulting in a twelve digit identification code.

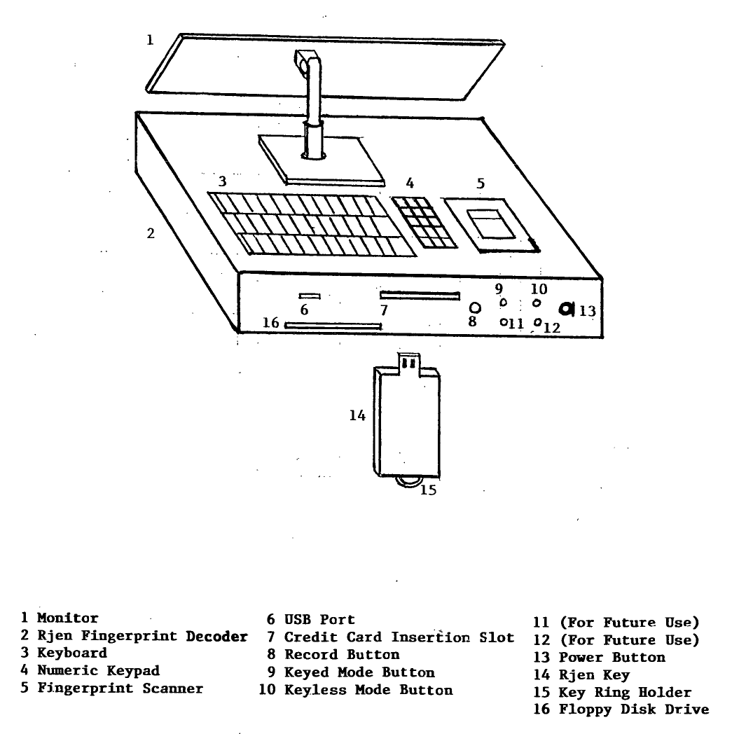

### DETAILED DESCRIPTION OF THE INVENTION

The Rjen Fingerprint Decoder) The Rjen Fingerprint Decoder (herinafter also called the “Rjen System”) is a software driven, computerized system that will convert a scanned fingerprint image into a twelve (12) digit numerical code for identification purposes, in conjunction with, but not limited to, credit card transactions. This conversion process, which is uniquely available in the Rjen System in today's market, is accomplished by the sequential performance of five basic functions which are explained in detail below.

Step 1: Identifying the Fingerprint Pattern Type.

There are eight (8) basic fingerprint pattern types known to man, namely the double loop, the plain arch, the central pocket loop, the ulnar loop, the accidental, the tented arch, the plain whorl and the radial loop pattern. The Rjen System maintains a “library” where one example of each of the pattern types is stored. The Rjen Library therefore would contain eight “characters” where a character would be one of the sample patterns. When presented with a fingerprint for conversion into a numerical code, the Rjen System scans its library looking for a character that most accurately matches the pattern in the submitted print. Once having determined which pattern is present in the submitted print, the Rjen System will proceed to Step 2. The preceding process of searching for and identifying a particular character in a library is an elementary and basic function of most average word processors which are readily available on the market today. This process is understood by anyone skilled in the technological area of word processing including the spell-check feature or a search-and-find feature in such a processor where a word displayed on the screen is checked against the contents of the word processor's “library” or dictionary. This is similar to the process used by the Rjen System with the exception that the library contains fingerprint patterns instead of words. Rather than an exact match at this stage of the process, the Rjen System uses a “looks like” function to determine the closest match for the fingerprint pattern displayed on the screen from among the patterns in its library. The “looks like” function is understood by anyone familiar with the technology of electronic dictionaries on the market that allow the user to verify the correct spelling of a misspelled word by retrieving the closest match to the displayed misspelled word from its database of dictionary words.

Step 2: Display the Identifying Pattern Portion of the Fingerprint Onscreen.

This is a basic cut and paste function common to any computer program that supports highlighting by using a mouse and is readily understood by anyone skilled in the technology required to move an object onscreen by highlighting the desired words or object(s), deleting the same, placing the cursor at the new point of insertion and relocating the object(s) to that position by clicking the mouse. The Rjen System performs a similar process by cutting the identifying fingerprint pattern from the displayed print and placing it in a predetermined position on the Coordinated Grid Calculator screen (discussed later), which is displayed on the monitor (1 on drawing) and which predetermined position is always the exact center of the screen. Once the fingerprint pattern (not the entire print) is centered on the Coordinated Grid Calculator (hereinafter called the CGC) screen, the Rjen System will proceed to Step 3.

Step 3: Cut and Paste the “Stray Dots” to the CGC Screen.

Dispersed throughout every fingerprint are random, extraneous dots, short lines, and other multi-shaped marking in addition to the basic uniform lines that identify the “pattern of the print. Each fingerprint has its own unique mix of markings. For the purposes of our discussion here, we will call this composite group of extraneous marking “stray dots”. Cutting or removing such stray dots from a displayed image is a common function of most OCR programs and photo enhancement programs that are readily available to the public on the market today. This function is used to “clean up” a photo or written document and obtain a “sharper” or “cleaner” resulting image. This function is familiar to anyone skilled in the technology and processes used in photo enhancement computer programs or a paper document management program that includes this process. The Rjen System uses a similar process to cut the stray dots from the fingerprint pattern image which is displayed on the CGC screen, and prints them to a temporary file. The remaining image on the screen is erased and the stray dots are then retrieved from the temporary file and displayed in the exact center of the CGC screen. Once the stray dots are thus displayed, the Rjen system will proceed to Step 4.

Step 4: Image Enlargement.

The “picture” of stray dots is enlarged to fill the CGC screen. Image enlargement is a basic computer function and is understood by anyone skilled in the technology required to increase the font size of a displayed onscreen document. Once enlarged, the stray dots are assigned a numerical value which is Step 5 of the conversion process.

Step 5: Stray Dot Conversion to Numerical Values.

To understand this process, it will first be necessary to know how the CGC functions. The CGC is formed by intersecting five (5) equi-spaced vertical lines with four (4) equi-spaced horizontal lines thus forming twelve (12) equi-sized, four-sided adjoining cells. Each vertical and horizontal line is assigned a numerical value. For example, the five vertical lines, starting from left to right could be numbered 2, 4, 6, 8, and 10 while each of the horizontal lines starting from top to bottom could be numbered 1, 3, 5, and 7. The entire CGC is displayed on the monitor screen. The first sector, Sector 1, located in the upper left hand corner, would therefore be formed by having a vertical line with a value of 1 as the left border of the sector; a horizontal line with a value of 2 across the top of the sector; a vertical line with a value of 4 as the right side border of the sector; and a horizontal line with a value of 3 forming the bottom border of the sector. This same sequential numbering system would be followed throughout the entire grid. The first row of sectors starting from left to right would be sectors 1, 2, 3, and 4. The next row of sectors would be sectors 5, 6, 7, and 8. The third and last row of sectors would be sectors 9, 10, 11, and 12. The grid would therefore contain three (3) rows of four (4) cells each.

When the stray dots are centered on the CGC, each sector may have either no stray dots, a few stray dots, or several stray dots within its borders. The Rjen System would now commence to read or scan each sector from top to bottom and left to right beginning with Sector 1. It will calculate the value of the first stray dot it encounters in the scanning process, reading from left to right and top to bottom in each sector. The value assigned to the first encountered stray dot is determined by the value of the horizontal or vertical line closest to the encountered stray dot. For example, a dot located one inch to the right of vertical line 2 and two inches below horizontal line 1, would be assigned a value of 2 since it would be closer to vertical line 2 than it would be to horizontal line 1. If a sector contains more than one stray dot, the Rjen System will calculate the value of the first object it encounters in that cell as it reads from top to bottom and right to left.

If a sector contains no objects, the Rjen System defaults to a fixed value for each sequential empty sector it encounters. The default for the first empty sector encountered is 3, the second 5, the third 7, and so forth in increments of 2 for any remaining empty sectors encountered. If the end calculation for any sector results in a two (2) digit number, such as 13, the Rjen System by default will convert the number 13 into a one (1) digit number by adding the two digits together. Thus the number 13 would be converted to the number 4. Each sector, then, whether it contains no objects or several objects, would always have a single digit value assigned, producing in all, a 12 digit number which is the Identification Code for that particular fingerprint. This 12 digit number is then printed to the monitor screen (1 on drawing).

Assigning numerical values to locations on a grid based on relative positioning is a common feature available on all electronic maps on the market today. As the mouse is moved across the electronic map with this feature, a numerical readout at the bottom of the screen constantly changes, reflecting the longitude and latitude of the city, landmark, mountain range, or other specific site selected by the mouse. As the lines of longitude and latitude have fixed values, the horizontal and vertical lines on the CGC have fixed values. As the readout changes with the movement of the mouse on the electronic map, the value of a stray dot on the CGC is determined as the scan moves across it, based on its location in relation to the horizontal and vertical lines. This process of determining a numerical value for a fixed location is understood by anyone familiar with the technology required to execute the readout of the longitude and latitude of a fixed point on electronic maps.

The Rjen System innovatively uses practical, simple, and common computer routines to obtain a desired result. It is the precise blending, implementation, integration, and coordination of these functions and routines that produce the end result of converting a fingerprint into a numerical string.

This product that converts a scanned fingerprint into a numerical code is new and unique on today's market. The only product with this feature is the Rjen Fingerprint Decoder.

The Rjen Fingerprint Decoder successfully meets and overcomes the major challenge that heretofore has prevented numerous aspiring inventors from converting a fingerprint into a numerical sequence and that challenge has been the placement of the fingertip pad on the scanning screen which needed to be in the exact same position for each scan or else the results would be different for each scan of the same fingerprint. Of course the client would be unable to duplicate the exact placement of his finger tip pad from the previous scan.

The Rjen System overcomes this problem in that it looks for a fingerprint “pattern”, wherever it may be on the scanning surface (5 on drawing) and once it “sees” that pattern, the Rjen System places that pattern, electronically, in the exact same location each time, onto the screen of the CGC and from that location it is analyzed and processed. The client only needs to provide a fingerpint pattern, in any location, on the scanning surface (5 on drawing) where it can be seen by the Rjen System. The Rjen system takes over from that point. In this, the Rjen Fingerprint Decoder is a unique device and the only one of its kind currently available on the market today.

### ADDITIONAL FEATURES OF THE RJEN FINGERPRINT DECODER

In addition to the primary function of the Rjen Fingerprint Decoder, which is the conversion of fingerprints into numerical characters, which feature alone deals a most lethal and effective blow against credit card and identity theft, the Rjen System is currently poised to function in a cardless credit society, yet future, where what is known today as a “credit card transaction” will still take place but without the use of a physical plastic object that we call a credit card. This feature will be explained in detail below. Finally, the Rjen System is fully capable of comparing two fingerprints in order to determine the identity of any person where a measure of security is required. Additionally, two of the activation buttons on the front panel of the unit (11 and 12 on drawing) are reserved for still future enhancements which are currently under development.

First we will detail the Cardless System function of the Rjen System. For the purposes of this function, we will call it the “Keyed Mode”. This mode requires the use of the Rjen Key (14 on drawing). The Rjen Key is essentially a miniature hard drive and its function would be understood by anyone skilled in the technological field of hard drive function and components.

The Rjen Key is inserted in the USB port (6 on drawing). Once inserted, the previously encoded fingerprint is copied from the Key and displayed on the monitor (1 on drawing). The client is then asked to present the same finger for scanning by pressing it against the scanning surface (5 on drawing). The newly scanned image is written to the screen by the system alongside the first image. The encoded image from the Key is displayed in yellow and the freshly scanned print is displayed in blue. The Rjen system will then superimpose one image over the other. All matching details will be displayed in green (yellow and blue make green). When a predetermined percentage of green is displayed onscreen, for example, 95%, the System will respond with a display reading “ID Confirmed”. The process of superimposing one-image over another and obtaining a certain color and color saturation percentage is understood by anyone familiar with the technology required in the field of graphic arts as applied in today's computers.

At this point, the client will key in the code for the credit card he wishes to use such as AX, MC, Dc etcetera, using the Keyboard (3 on drawing). All of the credit card numbers the client may wish to use for purchases will have been previously encoded onto his Rjen Key. However, only the number for the credit card code he actually keys in will be used for the transaction at hand. From this point on, the transaction will proceed as an ordinary credit card purchase, however, no physical credit card will have been used, instead the secure Rjen Key is used. If the Rjen Key is lost, the finder will not be able to use the Key without matching the fingerprint that is encoded on the Key with one of his own which is impossible due to no two human fingerprints being identical.

It is hoped and anticipated that credit card issuing companies will soon see the value and cost saving potential of operating without using physical cards. Until such time that the market actually catches up with the Rjen System, it should be noted that the Rjen Fingerprint Decoder will also accept and process a plastic credit card that may be used for a business transaction, either with or without being Rjen-enabled. However, only Rjen-enabled cards will activate the Rjen System which requires that the owner of the card submit a fingerprint for identification. Credit cards that are not Rjen-enabled can be used by anyone other than the owner which could, and has, resulted in acts of fraud. A credit card is Rjen-enabled by having the Rjen logo permanently affixed to the front of the credit card. This specialized strip of metallic tape will be detected by the Rjen System which would then initiate the identification process. This process is understood by anyone skilled in the field of detection methods used by floppy disk drives and CD Rom drives that detect the prescence of a disk in the drive.

As is quite evident, the Keyed Mode requires the use of the Rjen Key (14 on drawing) which would replace and eliminate the need to carry credit cards. The former credit card user would simply carry the Rjen Key (14 on drawing). The Rjen Key (14 on drawing) is quite small and can easily be carried on a keyring using the key ring holder (15 on drawing) conveniently attached to the Rjen Key. The Rjen Key is encoded with the necessary information by inserting it into the USB Port (6 on drawing) on the front side of the Rjen Fingerprint Decoder unit and simply typing in the codes and account numbers for the credit cards intended for use with the Rjen System. Additionally, the client would scan a fingerprint to be used for identification purposes. The scanned image and the credit card account information is then simply written to the Rjen Key. The process of writing or copying data on a computer screen to a hard drive is understood by anyone skilled in the field of hard drive function and components. We will now discuss the Keyless Mode.

The Keyless Mode is the least likely mode to be used by an Rjen client because it is only invoked when the Rjen client has misplaced the Rjen Key and has no physical credit card and wishes to negotiate a credit card transaction. In this instance, the client must be able to produce his 12-digit ID code and his credit card account number. He must then verify that code by scanning a fingerprint. If the scanned print produces the same code as previously provided by the client, the merchant must then decide whether to proceed with the transaction or not. If the decision is to proceed, the client will be asked to press the Record Button (8 on drawing) on the unit which will retain a copy of the fingerprint at the unit. Prior to pressing the Record Key (8 on drawing), the client would be advised that the fingerprint and credit card account number will be recorded for future reference if needed. While it anticipated that this feature would not be used on a regular basis, in the event it is required, it is incorporated into the Rjen System and can be invoked when needed. The use of this function would be subject to any laws governing processes of this sort. The Rjen Fingerprint Decoder can easily be switched from one mode to another by the use of the Keyed Mode Button (9 on drawing) and the Keyless Mode Button (10 on drawing.)

Credit cards are processed via the Credit Card Insertion Slot (7 on drawing). The unit is turned on and off with the Power Button (13 on drawing). The Floppy Disk Drive (16 on drawing) accepts a three and quarter-inch floppy disk on which program upgrades and other enhancements can be installed in the system as needed.

1. A composite process is claimed whereby a scanned fingerprint is converted into a series of numbers which series can serve, among other things, but not limited to, an Identity Code for the individual providing the scanned print using one of his or her own fingers.
This process is comprised of:
1) Creating a Library of fingerprint “patterns” by creating a file which will reside on the hard-drive of the unit and will contain one sample each of the eight basic fingerprint patterns, namely the double loop, the plain arch, the central pocket loop, the ulnar loop, the accidental, the tented arch, the plain whorl and the radial loop patterns. The library is created by writing these pattern samples to the designated file on the hard-drive, thereby creating a library with eight characters with each fingerprint pattern being viewed as a “character.
2) Creating a Coordinated Grid Calculator by intersecting five equi-spaced vertical lines with 4 equi-spaced horizontal lines to form a grid consisting of twelve equally sized, four-sided cells with each vertical and horizontal line having a fixed and assigned numerical value.
3) Obtaining a scanned image of a fingerprint by pressing the pad of a fingertip against the screen of a fingerprint scanner and transferring the scanned image onto a computer monitor via a standard protocol connection between the scanner and the computer.
4) Identifying the basic pattern contained in the displayed scanned image by invoking a “search and find” routine where the content of the library file is accessed and each character in the library file is compared with the fingerprint pattern onscreen until the character with the highest percentage of similarity to the onscreen image is located.
5) Extracting the pattern from the displayed scanned image determined to be the closest match when compared with the characters in the library and writing it to a temporary file also resident on the hard-drive.
6) Invoking a routine to display the Coordinated Grid Calculator onscreen and copying the contents of the temporary file where the fingerprint pattern resides and superimposing the fingerprint pattern over the Coordinated Grid Calculator in such a manner that both the fingerprint pattern and the Coordinated Grid Calculator are visible and transparent.
7) “Cleaning Up” the image of the scanned fingerprint on the Coordinated Grid Calculator screen by a process of deleting all extraneous dots, markings, lines, and other bits of data from the scanned fingerprint image that are not an intrinsic part of the basic pattern as determined from comparing the scanned image with the contents of the library characters and saving them to a temporary file with residence on the hard-drive. Removing the remnant of the scanned fingerprint image from the Coordinated Grid Calculator by deleting it and copying the contents of the file containing the extraneous dots, markings, lines, and other bits of data previously saved, back onto the Coordinated Grid Calculator screen in such a transparent manner as to see the extraneous dots, markings, lines, and other bits of data dispersed throughout the cells of the Coordinated Grid Calculator and enlarging the composite image of such dots, markings, lines, and other bits of data in such a manner that the composite image is evenly dispersed over as large an area of the Coordinated Grid Calculator screen as possible.
8) Calculating the value of data in each cell of the Coordinated Grid Calculator by assigning a value to the first bit of data encountered in a specific cell as the cell is scanned from top to bottom and left to right simultaneously. Determining the value of the first encountered bit of data in a cell by detecting the vertical or horizontal line in nearest proximity to the bit of data and assigning the numerical pre-assigned value of that vertical or horizontal line to the selected bit of data. Assigning a default value to the first cell encountered which contains no data and a different default value to each additional cell containing no data and continuing this process of determining a value for the contents of each cell until twelve values have been determined which when assembled in a string would become the twelve-digit identification code obtained for the subject fingerprint.
9) Printing the twelve-digit number to the Coordinated Grid Calculator screen While the Rjen Fingerprint Decoder is a most powerful tool in the fight against credit card fraud and identity theft, it is to be understood that scope of application of the system is not limited to those two areas. The methodology and processes used by the Rjen Fingerprint Decoder can also be used to achieve the desired results of positive identification in other areas such as, but not limited to,
a) Automobile safety and security where the user of a vehicle must identify himself to the vehicle before being allowed entry into the vehicle.
b) Personal Computer Security where the user of a computer must identify himself as being authorized to access the subject computer system.
c) ATM Machines, where the user of the ATM machine must identify himself to the system prior to being allowed to initiate any type of financial transaction.
d) Worksite Security where an employee must verify his identity before being allowed access to a restricted area. Or to prove that an employee is in a certain area at a certain time such as at a time clock to verify the beginning and end of a work period.
e) Personal Item Identification where the personal Rjen ID Code for a client can be etched, stamped, or printed on personal property items as proof of ownership when a retrieved item must be identified after a theft.
Child Safety ID where parents can record an Rjen generated personal ID Code for their minor children and/or have the child wear an Rjen bracelet encoded with the child's ID number. A lost child can be quickly identified using this method.
It should be understood that the methodology and processes discussed herein as applicable to the Rjen Fingerprint Decoder, can be adapted by one knowledgeable in a pertinent field as the vehicle to obtain a desired result in numerous different fields of endeavor where identification verification and/or security are issues, and therefore claim is made as to the integration of the Rjen Fingerprint Decoder processes and methodology that result in identity confirmation, as integrated, used, or applied in products of any type other than their use as part of the Rjen Fingerprint Decoder.
